(19) United States
(12) Patent Application Publication
(10) Pub. No.: US 2018/0027514 A1
(43) Pub. Date: Jan. 25, 2018

(54) RESOURCE UNIT INDICATION FOR EXTENDED RANGE PACKETS

(71) Applicants: Xiaogang Chen, Hillsboro, OR (US); Qinghua Li, San Ramon, CA (US); Feng Jiang, Santa Clara, CA (US); Ilan Sutskover, Hadera (IL); Robert J. Stacey, Portland, OR (US)

(72) Inventors: Xiaogang Chen, Hillsboro, OR (US); Qinghua Li, San Ramon, CA (US); Feng Jiang, Santa Clara, CA (US); Ilan Sutskover, Hadera (IL); Robert J. Stacey, Portland, OR (US)

(21) Appl. No.: 15/391,601

(22) Filed: Dec. 27, 2016

Related U.S. Application Data
(60) Provisional application No. 62/364,632, filed on Jul. 20, 2016.
(60) Provisional application No. 62/365,571, filed on Jul. 22, 2016.

(51) Int. Cl. H04W 56/00; H04L 27/26; H04B 7/04

(52) U.S. Cl. CPC H04W 56/0005; H04B 7/0452; H04L 27/2601; H04W 84/12

(57) ABSTRACT

Methods, apparatuses, computer readable media for resource unit indication for extended range packets. An apparatus of a wireless device comprising processing circuitry is disclosed. The processing circuitry may be configured to: encode a high-efficiency (HE) extended range (ER) physical (PHY) layer convergence procedure (PLCP) protocol data unit (HE ER PPDU) including a first portion comprising a HE signal (SIG) field, and including a second portion comprising a data field. The HE SIG field may include an indication of a resource unit (RU) for the second portion. The processing circuitry further configured to configure the access point to transmit the first portion on a 20 MHz channel, and to transmit the second portion on the RU, the RU within the 20 MHz channel.

### PRIORITY CLAIM

This application claims the benefit of priority under 35 USC 119(e) to U.S. Provisional Patent Application Ser. No. 62/364,632, filed Jul. 20, 2016, and U.S. Provisional Patent Application Ser. No. 62/365,571, filed Jul. 22, 2016, both of which are incorporated herein by reference in their entirety.

### TECHNICAL FIELD

Embodiments relate to Institute of Electrical and Electronic Engineers (IEEE) 802.11. Some embodiments relate to high-efficiency (HE) wireless local-area networks (WLANs). Some embodiments relate to IEEE 802.11ax. Some embodiments relate to computer readable media, methods, and apparatuses for resource unit (RU) indication for extended range (ER) packets. Some embodiments relate to computer readable media, methods, and apparatuses for HE ER single user (SU) physical layer convergence procedure (PLCP) protocol data units (PPDUs)(HE ER SU PPDUs).

### BACKGROUND

Efficient use of the resources of a wireless local-area network (WLAN) is important to provide bandwidth and acceptable response times to the users of the WLAN. However, often there are many devices trying to share the same resources and the devices may interfere with one another. Additionally, the wireless devices may be moving and the signal quality may be changing. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates resource units (RUs) for HE ER SU PPDUs in accordance with some embodiments;

FIG. 3 illustrates RUs for HE ER SU PPDUs in accordance with some embodiments;

FIG. 4 illustrates an RU for HE ER SU PPDUs in accordance with some embodiments;

FIG. 5 illustrates a HE ER SU PPDU in accordance with some embodiments;

FIG. 6 illustrates HE signal A (HE-SIG-A) in accordance with some embodiments;

FIG. 7 illustrates bandwidths for channels for the lower 5 GHZ band and the higher 5 GHz band in accordance with some embodiments;

FIG. 8 a method for RU indication for HE ER SU PPDU in accordance with some embodiments;

FIG. 9 a method for RU indication for HE ER SU PPDU in accordance with some embodiments; and

FIG. 10 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

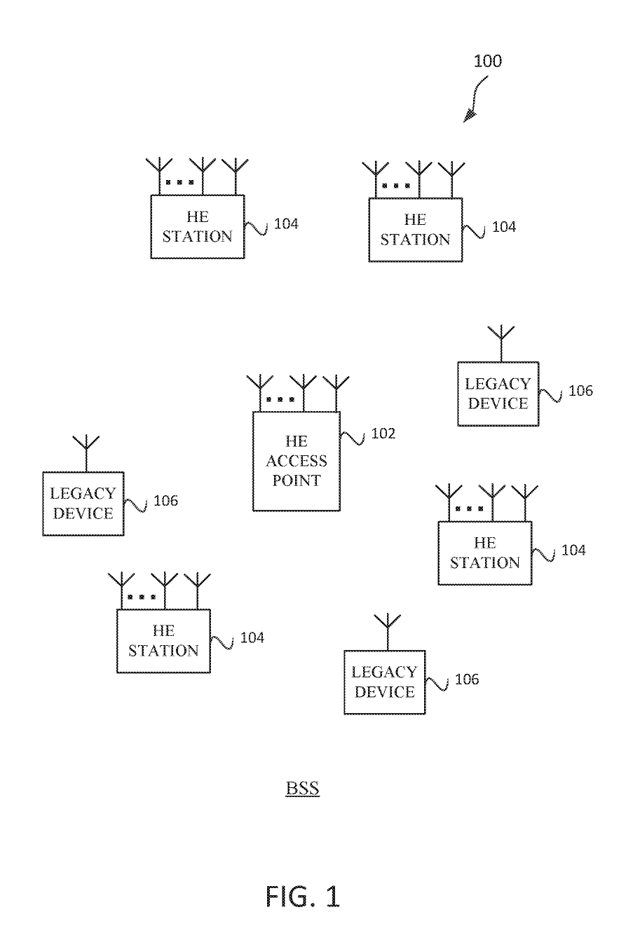

FIG. 1 illustrates a WLAN 100 in accordance with some embodiments. The WLAN 100 may comprise a BSS 100 that may include a HE access point 102, which may be an AP, a plurality of HE stations 104 (e.g., IEEE 802.11ax), and a plurality of legacy (e.g., IEEE 802.11n/ac) devices 106.

The HE access point 102 may be an AP using the IEEE 802.11 to transmit and receive. The HE access point 102 may be a base station. The HE access point 102 may use other communications protocols as well as the IEEE 802.11 protocol. The IEEE 802.11 protocol may be IEEE 802.11 ax. The IEEE 802.11 protocol may include using orthogonal frequency division multiple-access (OFDMA), time division multiple access (TDMA), code division multiple access (CDMA), space-division multiple access (SDMA), and/or multiple-user multiple-input multiple-output (MU-MIMO). There may be more than one HE access point 102 that is part of an extended service set (ESS). A controller (not illustrated) may store information that is common to the more than one HE access points 102. In some embodiments, the BSS 100 may include a management entity (not illustrated), which may manage one or more BSSs. In some embodiments, the BSS 100 may include a router (not illustrated) that provides access to another network such as the Internet.

The legacy devices 106 may operate in accordance with one or more of IEEE 802.11 a/b/g/n/ac/ad/af/ah/aj/ay, or another legacy wireless communication standard. The legacy devices 106 may be stations or IEEE stations. The HE stations 104 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE stations 104 may be termed stations, HE stations, or stations (STAs).

The HE access point 102 may communicate with legacy devices 106 in accordance with legacy IEEE 802.11 communication techniques. In example embodiments, the HE access point 102 may also be configured to communicate with HE stations 104 in accordance with legacy IEEE 802.11 communication techniques.

In some embodiments, a HE frame may be configurable to have the same bandwidth as a channel. The HE frame may be a PPDU. In some embodiments, there may be different types of PPDUs that may have different fields and different physical layers and/or different media access control (MAC) layers. In some embodiments, there may be different PPDU formats for different communication standards, e.g., a non-high-throughput (non-HT) PPDU for IEEE 802.11a, HT PPDU for IEEE 802.11n, very HT (VHT) PPDU for IEEE 802.11ac, or HE PPDU for IEEE 802.11ax.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz, 40 MHz, 80 MHz, 160 MHz, or 320 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a RU allocation in accordance with some embodiments.

In some embodiments, a 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE frame may be configured for transmitting a number of spatial streams, which may be in accordance with MU-MIMO and may be in accordance with OFDMA. In other embodiments, the HE access point 102, HE STA 104, and/or legacy device 106 may also implement different technologies such as CDMA 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11 embodiments, e.g., IEEE 802.11ax embodiments, a HE access point 102 may operate as a HE access point which may be arranged to contend for a wireless medium (e.g., during a contention period) to receive exclusive control of the medium for an HE control period. In some embodiments, the HE control period may be termed a transmission opportunity (TXOP). The HE access point 102 may transmit a HE trigger frame, at the beginning of the HE TXOP. The HE access point 102 may transmit a time duration of the TXOP, RU information, etc. During the HE TXOP, HE STAs 104 may communicate with the HE access point 102 in accordance with a non-contention based multiple access technique such as OFDMA or MU-MIMO. This is unlike conventional WLAN communications in which devices communicate in accordance with a contention-based communication technique, rather than a multiple access technique. During the HE TXOP, the HE access point 102 may communicate with HE stations 104 using one or more HE frames. During the HE TXOP, the HE stations 104 may operate on a channel smaller than the operating range of the HE access point 102. In some embodiments, the trigger frame may indicate one or more RUs which may be contention based for HE stations 104 and/or HE access point 102 during the TXOP. During the HE TXOP, legacy stations refrain from communicating. The legacy stations may need to receive the communication from the HE access point 102 to defer from communicating.

In accordance with some embodiments, during the HE TXOP the HE stations 104 may contend for the wireless medium with the legacy devices 106 being excluded from contending for the wireless medium during the HE TXOP. In some embodiments the trigger frame may indicate an UL MU-MIMO and/or UL OFDMA TXOP. In some embodiments, the trigger frame may include a DL MU-MIMO and/or DL OFDMA with a schedule indicated in a preamble portion of trigger frame for the HE stations 104 to decode the DL data and/or frame.

In some embodiments, the multiple-access technique used during the HE TXOP may be a scheduled OFDMA technique, although this is not a requirement. In some embodiments, the multiple access technique may be a TDMA technique, FDMA technique, SDMA, and/or CDMA.

The HE access point 102 may also communicate with legacy stations 106 and/or HE stations 104 in accordance with legacy IEEE 802.11 communication techniques. In some embodiments, the HE access point 102 may also be configurable to communicate with HE stations 104 outside the HE TXOP in accordance with legacy IEEE 802.11 communication techniques, although this is not a requirement.

In some embodiments the HE station 104 may be a “group owner” (GO) for peer-to-peer modes of operation. A wireless device may be a HE station 102 or a HE access point 102. In some embodiments, the HE station 104 and/or HE access point 102 may be configured to operate in accordance with IEEE 802.1mc. In some embodiments, one or more IEEE 802.11 communication standards may be termed WiFi. A HE station 104 and/or HE access point 102 may be termed an HE device (e.g., station or AP), if the HE device complies with wireless communication standard IEEE 802.11ax. In some embodiments, the HE stations 104 may have limited power. In some embodiments, the HE stations 104 may have limited power and may transmit on an RU less than 20 MHz in order to reach the HE access point 104.

In example embodiments, the HE station 104 and/or the HE access point 102 are configured to perform the methods and functions described herein in conjunction with FIGS. 1-10.

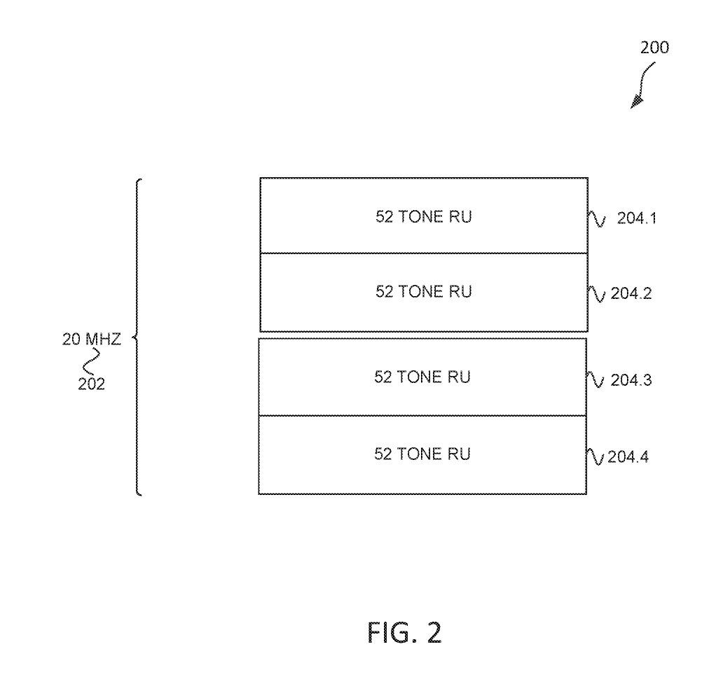

FIG. 2 illustrates resource units (RUs) 200 for HE ER SU PPDUs in accordance with some embodiments. Illustrated in FIG. 2 is a 20 MHz 202 bandwidth with four 52 tone RUs 204.1 through 204.4.

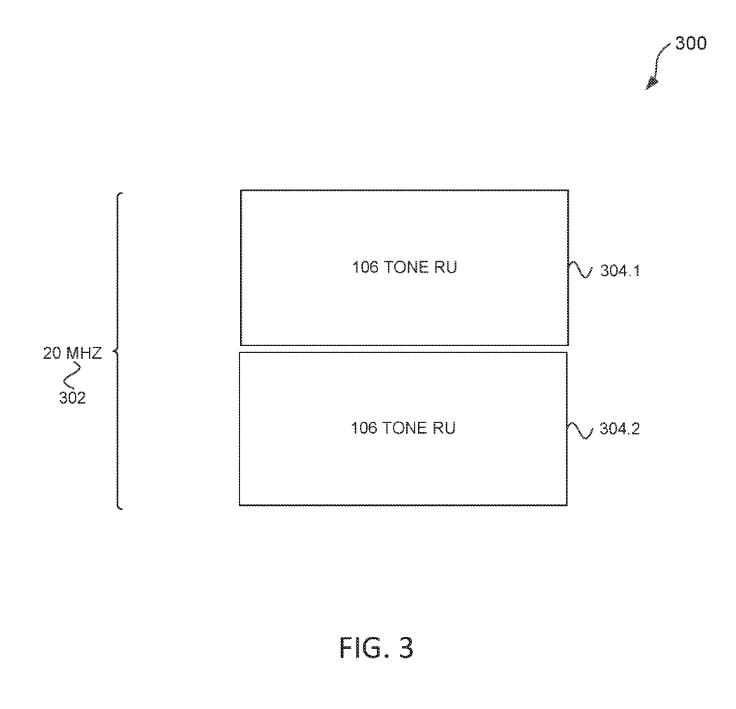

FIG. 3 illustrates RUs 300 for HE ER SU PPDUs in accordance with some embodiments. Illustrated in FIG. 3 is a 20 MHz 302 bandwidth with two 106 tone RUs 304.1 and 304.2.

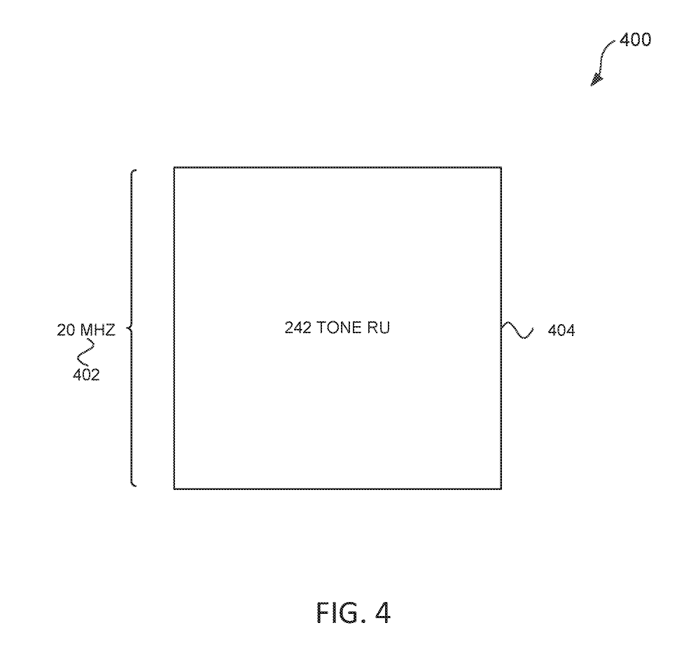

FIG. 4 illustrates an RU 400 for HE ER SU PPDUs in accordance with some embodiments. Illustrated in FIG. 4 is a 20 MHz 402 bandwidth with one 242 tone RU 404.

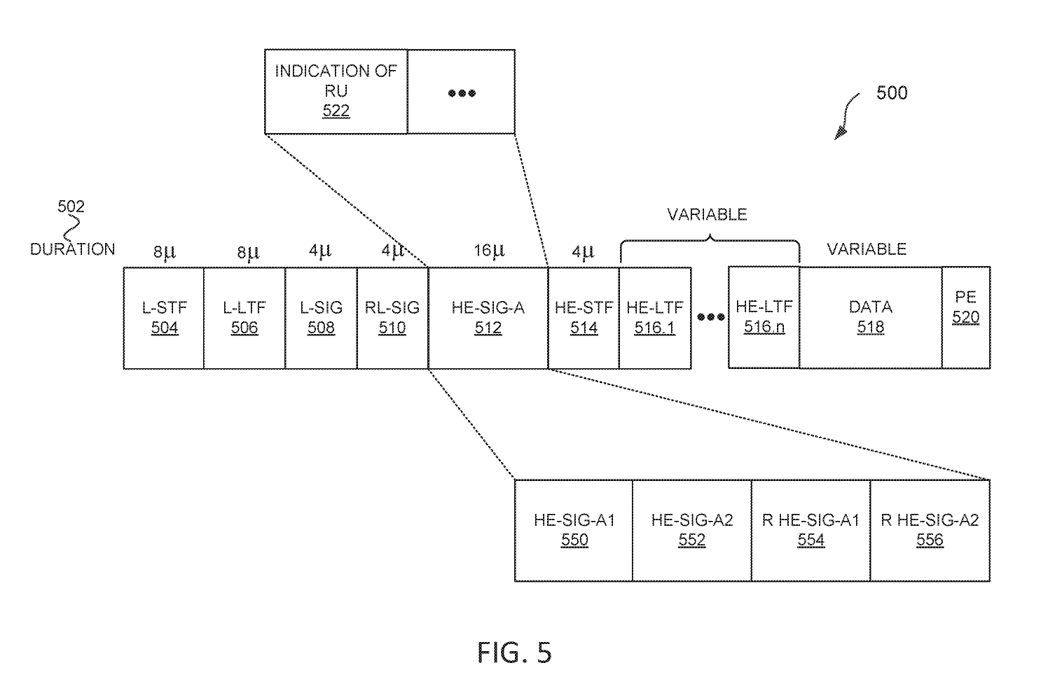

FIG. 5 illustrates a HE ER SU PPDU 500 in accordance with some embodiments. Illustrated in FIG. 5 is the HE ER SU PPDU 500 and duration 502. The duration 502 indicates the duration of fields in accordance with some embodiments. The HE ER SU PPDU 500 may include legacy (L) short-training field (L-STF) 504, L long training field (L-LTF) 506, L signal (L-SIG) 508 field, repeated L-SIG 510, HE-SIG-A 512, HE-STF 514, HE-LTF 516.1 through HE-LTF 516.n, data 518, and packet extension (PE) 520 field. The HE-SIG-A 512 may include a HE-SIG-A1 and HE-SIG-A2, in accordance with some embodiments. The HE-SIG-A 512 may include a HE-SIG-A1 550, a HE-SIG-A2 552, a repeated (R) HE-SIG-A1 554, and R-HE-SIG-A2 556.

The HE-SIG-A 512 may include an indication of the RU 522 the ER SU PPDU 500 is to be transmitted on. In some embodiments, the indication of the RU 522 indicates the RU the remainder of the ER SU PPDU 500 is to be transmitted on, e.g., the HE-STF 514, HE-LTF 516.1 through HE-LTF 516.n, data 518 field, and PE 520 field. In some embodiments, the indication of the RU 522 indicates the RU the data 518 is to be transmitted on. In some embodiments, the HE access point 104 is configured to transmit the data 518 field on the RU indicated by the indication of the RU 522. In some embodiments, the HE access point 104 is configured to transmit the data 518 field signals on the RU indicated by the indication of the RU 522 within a 20 MHz channel. The indication of the RU 522 may indicate an RU (e.g., 204, 304, or 404) within a 20 MHz bandwidth.

In some embodiments, the HE ER SU PPDU 500 may be termed an ER SU HE-PPDU, HE ER SU PPDU, ER HE SU PPDU, and/or HE ER PPDU.

Table 1 indicates fields of HE-SIG-A1 550 and Table 2 indicates fields of HE-SIG-A2 552. In some embodiments, one or both of reserve bits B0 and B15 of Table 1 are used for the indication of RU 522. In some embodiments, a format field of HE-SIG-A1 550 is used for the indication of RU 522, e.g., B1 (format) of Table 1 is used for the indication of RU 522. In some embodiments B1 is not needed for HE ER SU PPDU 500, since the PPDU type is different from both HE TB PPDU and HE SU PPDU.

In some embodiments, bits or values of a bandwidth field of HE-SIG-A1 550 is used for the indication of RU 522, e.g., B20 and/or B21 of Table 1 is used for the indication of RU 522. In some embodiments, B20 and/or B21 is not needed for HE ER SU PPDU 500 because the bandwidth for HE ER SU PPDU 500 is 20 MHz.

In some embodiments, bits or values of a modulation and coding scheme (MCS) field of the HE-SIG-A1 550 is used for the indication of RU 522, e.g., one or more of bits B22 through B25 of Table 1 are used for the indication of RU 522. In some embodiments, the MCS field, e.g., one or more of B22 through B25, is not needed for HE ER SU PPDU 500 because the bits are part of an MCS field and all the MCS values may not be needed for the HE ER SU PPDU 500 since the MCS may be fixed or only lower MCSs may be used.

TABLE 1
HE-SIG-A1

| | | # | |
|---|---|---|---|
| | | OF | |
| BITS | FIELD | BITS | DESCRIPTION |
| B0 | Reserved | 1 | Reserved and set to 1. |
| B1 | Format | 1 | Set to 0 for HE trigger-based (TB) |
| | | | PPDU. |
| | | | Set to 1 for HE SU PPDU. |
| B2 | UL/DL | 1 | Indicates whether the PPDU is sent |
| | | | UL or DL. |
| | | | Set to 0 for DL. |
| | | | Set to 1 for UL. |
| | | | This field indicates DL for TDLS. |
| B3:B8 | BSS Color | 6 | The BSS Color field is an identifier |
| | | | of the BSS. Set to all 1's for no |
| | | | BSS color. |
| B9:B12 | Spatial | 4 | To be determined. |
| | Reuse | | |
| B13:B19 | TXOP | 7 | Indicates the remaining time in the |
| | Duration | | current TXOP. |
| B20:B21 | Bandwidth | 2 | For HE SU PPDU: |
| | | | Set to 0 for 20 MHz |
| | | | Set to 1 for 40 MHz |
| | | | Set to 2 for 80 MHz |
| | | | Set to 3 for 160/80 + 80 MHz |
| B22:B25 | Modulation | 4 | For HE SU PPDU. |
| | and Coding | | Set to 0 for MCS0. |
| | Scheme | | Set to 1 for MCS1. |
| | (MCS) | | Set to 2 for MCS2. |
| | | | Set to 3 for MCS3. |
| | | | Set to 4 for MCS4. |
| | | | Set to 5 for MCS5. |
| | | | Set to 6 for MCS6. |
| | | | Set to 7 for MCS7. |
| | | | Set to 8 for MCS8. |
| | | | Set to 9 for MCS9. |
| | | | Set to 10 for MCS10. |
| | | | Set to 11 for MCS11. |
| | | | Values 12-15 are reserved. |
| | | | For HE Extended Range PPDU: |
| | | | Set to 0 for MCS0. |
| | | | Set to 1 for MCS1. |
| | | | Set to 2 for MCS2. |
| | | | Values 3-15 are reserved. |

In some embodiments, bits or values of a number of spatial streams field of the HE-SIG-A2 552 may be used for the indication of RU 522, e.g., one or more of bits B4 through B6 of Table 2 are used for the indication of RU 522. In some embodiments, the number of spatial streams field, e.g., one or more of B4 through B6, is not needed for HE ER SU PPDU 500 because the bits are used for indicating a number of STSs, and the number of STSs for HE ER SU PPDU 500 may not need to be signaled and may be one.

In some embodiments, bits or values of a packet extension field of the HE-SIG-A2 552 may be used to represent the indication of RU 522, e.g., one or more of bits B10 through B12 of Table 2 are used for the indication of RU 522. In some embodiments, the packet extension field, e.g., one or more of B10 through B12, is not needed for HE ER SU PPDU 500 because the receiver of the HE ER SU PPDU 500 may not need the bits. For example, the HE ER SU PPDU 500 may only be 52 or 106 tones with a low MCS, so the packet extension may not be needed to give the receiver more time.

In some embodiments, bits or values of a cyclic prefix (CP) field and/or LTF type field, e.g., one or more of bits B0 and B1 of Table 2, is used for the indication of RU 522. In some embodiments, one or more of B0 and B1 are not needed for HE ER SU PPDU 500 because the bits are used for indicating a CP and/or LTF type, and HE ER SU PPDU 500 may require only a couple of values for the CP and/or LTF type.

TABLE 2
HE-SIG-A2

| | | # | |
|---|---|---|---|
| | | OF | |
| BITS | FIELD | BITS | DESCRIPTION |
| B0:B1 | CP and | 2 | Set to 0 for 1x HE-LTF + 0.8 μs. |
| | LTF Type | | Set to 1 for 2x HE-LTF + 0.8 μs. |
| | | | Set to 2 for 2x HE-LTF + 1.6 μs. |
| | | | Set to 3 for 4x HE-LTF + 3.2 μs. |
| B2 | Coding | 1 | Indicates whether BCC or LDPC is |
| | | | used. |
| | | | Set to 0 for binary convolutional coding |
| | | | (BCC). |
| | | | Set to 1 for low-density parity-check |
| | | | (LDPC). |
| B3 | LDPC | 1 | Indicates presence of extra OFDM |
| | Extra | | symbol for LDPC. |
| | Symbol | | Set to 0 for LDPC extra symbol not |
| | | | present. |
| | | | Set to 1 for LDPC extra symbol present. |
| | | | Note: This field is reserved and set to 1 |
| | | | when Coding field is set to 0. |
| B4:B6 | number of | 3 | Indicates the number of spatial streams. |
| | space time | | For HE SU PPDU: |
| | streams | | Set to 0 for 1 space time stream. |
| | (N_STS) | | Set to 1 for 2 space time stream. |
| | | | Set to 2 for 3 space time stream. |
| | | | Set to 3 for 4 space time stream. |
| | | | Set to 4 for 5 space time stream. |
| | | | Set to 5 for 6 space time stream. |
| | | | Set to 6 for 7 space time stream. |
| | | | Set to 7 for 8 space time stream. |
| | | | For HE ER SU PPDU: |
| | | | Set to 0 for 1 space time stream. |
| | | | Values 1-7 are reserved. |
| B7 | space-time | 1 | Set to 1 if STBC is used. |
| | block | | Set to 0 otherwise. |
| | coding | | |
| | (STBC) | | |
| B8 | TxBF | 1 | Set to 1 if a Beamforming (BF) steering |
| | | | matrix is applied to the waveform in an |
| | | | SU transmission. |
| | | | Set to 0 otherwise. |
| B9 | dual | 1 | Set to 1 to indicate that the payload of |
| | subcarrier | | the SU PPDU is modulated with dual |
| | modulation | | sub-carrier modulation for the MCS. |
| | (DCM) | | Set to 0 indicates that the payload of the |
| | | | PPDU is not modulated with dual sub- |
| | | | carrier for the MCS. |
| | | | DCM is only applicable to MCS0, |
| | | | MCS1, MCS3, and MCS4. |
| | | | DCM is only applicable to 1 and 2 |
| | | | spatial streams. |
| | | | DCM is not applicable to STBC. |
| B10:B12 | Packet | 3 | The First two bits B10, B11 indicate the |
| | Extension | | “a-factor”. The third bit B12 indicates |
| | | | the “PE-Dis-ambiguity,” which may |
| | | | determine equations to use for |
| | | | decoding. |
| B13 | Beam | 1 | Set to 1 to indicate that the pre-HE STF |
| | Change | | portion of SU PPDU is spatially |
| | | | mapped differently from HE-LTF1. |
| | | | Set to 0 to indicate that the pre-HE STF |
| | | | portion of SU PPDU is spatially |
| | | | mapped the same way as HE-LTF1 |
| | | | on each tone. |
| B14 | Doppler | 1 | |
| B15 | Reserved | 1 | Reserved and set to 1. |
| B16:B19 | CRC | 4 | CRC of bits 0-41 in HE-SIG-A. |
| B20:B25 | Tail | 6 | Used to terminate the trellis of the |
| | | | convolution decoder. |
| | | | Set to 0. |

In some embodiments, different fields and/or values for a field may be used for the indication of RU 522. In some embodiments, combinations of the bits and/or values of the above fields may be used to represent the indication of RU 522.

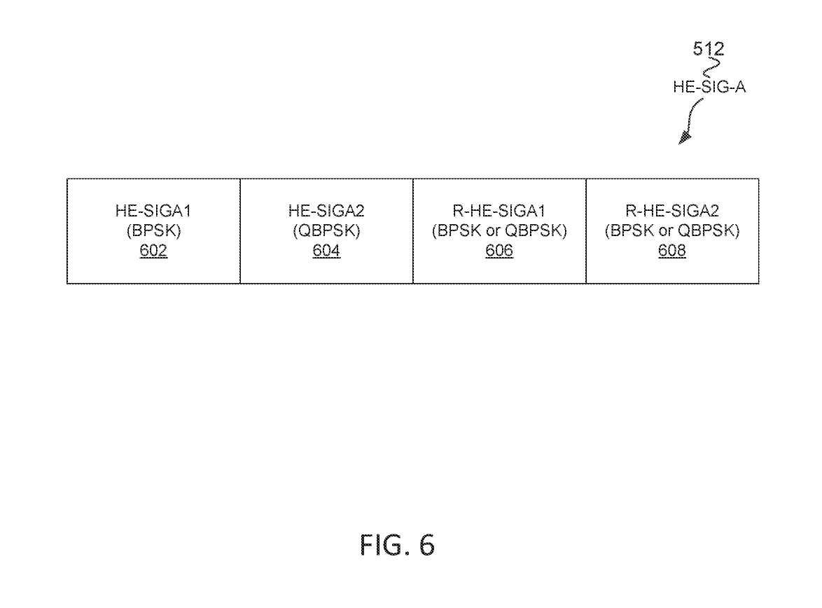

FIG. 6 illustrates HE signal A (HE-SIG-A) 512 in accordance with some embodiments. HE-SIG-A 512 may include HE-SIGA1 602, HE-SIGA2 604, R-HE-SIGA1 606, and R-HE-SIGA2 608. The modulation of HE-SIGA1 512 is binary phase shift keying (BPSK) and the modulation of HE-SIGA2 604 is quadrature phase shift keying (QPSK), in accordance with some embodiments. The modulation of HE-SIGA1 512 and HE-SIGA2 604 is used to indicate a packet type, e.g., HE ER SU PPDU 500. In some embodiments, the modulation of R-HE-SIGA1 606 and R-HE-SIGA2 608 is used for the indication of RU 522. Table 3 illustrates modulations of R-HE-SIGA1 and R-HE-SIGA2 that may be used for indication of RU 522. For example, the modulations may create four entries which may indicate different RUs for the indication of RU 522.

TABLE 3
Modulations of R-HE-SIGA1 and R-HE-SIGA2

| Entry | R-HE-SIGA1 | R-HE-SIGA2 |
|---|---|---|
| 1 | BPSK | BPSK |
| 2 | BPSK | QBPSK |
| 3 | QBPSK | BPSK |
| 4 | QBPSK | QBPSK |

Table 4 is an embodiment of indication of RU 522. There may be seven (7) values for the indication of RU 522 that indicate an RU (e.g., 204, 304, or 404) with a 20 MHz bandwidth. Different indication of RU 522 values may be used to indicate different RUs, e.g., the value of 4 may indicate 242 tone RU 404 rather than 52 tone RU 204.2.

TABLE 4
An Embodiment of Indication of RU

| Indication of RU 522 | RU |
|---|---|
| 1 | 52 tone RU 204.1 |
| 2 | 52 tone RU 204.2 |
| 3 | 52 tone RU 204.3 |
| 4 | 52 tone RU 204.4 |
| 5 | 106 tone RU 304.1 |
| 6 | 106 tone RU 304.2 |
| 7 | 242 tone RU 404 |

As disclosed herein different bits of the HE-SIG-A 512 may be used for the indication of RU 522 as well as the modulations of R-HE-SIGA1 606 and R-HE-SIGA2 608. For example, one or more of the following may be used to represent the indication of RU 522: the modulation of R-HE-SIGA1 606, the modulation of R-HE-SIGA2 608, one or more of bits B0 and B15 of Table 1, one or more bits B20 and B21 of Table 1, one or more of bits B22 through B25 of Table 1, one or more of bits B4 through B6 of Table 2, one or more of bits B10 through B12 of Table 2, one or more of bits B0 and B1 of Table 2, bits or values of reserved fields, bits or values of a BW field, bits or values of a MCS field, bits or values of a N_STS, bits or values of a packet extension field, and/or bits or values of a CP/LTF field.

Table 4 may need 3 bits to represent indication of RU 522 1 through 7. As an example, a modulation of R-HE-SIGA1 606 may be used in conjunction with bits B0 and B15 of Table 1. In some embodiments, any combination of bits and values of a field or fields may be used to provide the seven values of the indication of RU 522. In addition, a portion of a range of a field that is not being used for the HE ER SU PPDU 500 may be used, e.g., the unused values for the N_STS field of Table 2.

TABLE 5
An Embodiment of Indication of RU

| Indication of RU 522 | RU |
|---|---|
| 1 | 106 tone RU 304.1 |
| 2 | 106 tone RU 304.2 |
| 3 | 242 tone RU 404 |

Table 5 is an embodiment of indication of RU 522. There may be three (3) values for the indication of RU 522 that indicate an RU (e.g., 304 or 404) within a 20 MHz bandwidth. Different indication of RU 522 values may be used to indicate different RUs, e.g., the value of 1 may indicate a 242 tone RU 404 rather than a 106 tone RU 304.1.

As an example, indication of RU 522 may be represented with a modulation of R-HE-SIGA1 606 in conjunction with bit B0 of Table 1. This would provide two bits or 4 possible values for indication of RU 522. In some embodiments, any combination of bits and modulations may be used to provide the three values of the indication of RU 522 of Table 5. In addition, a portion of a range of a field that is not being used for the HE ER SU PPDU 500 may be used, e.g., the unused values for the N_STS field of Table 2.

TABLE 6
An Embodiment of Indication of RU

| Indication of RU 522 | RU |
|---|---|
| 1 | 106 tone RU 304.1 or RU 304.2 |
| 2 | 242 tone RU 404 |

Table 6 is an embodiment of indication of RU 522. There may be two (2) values for the indication of RU 522 that indicate an RU (e.g., 304, or 404) within a 20 MHz bandwidth. Different indication of RU 522 values may be used to indicate different RUs, e.g., the value of 1 may indicate a 242 tone RU 404 rather than a 106 tone RU 304.1 or RU 304.2. Indication of RU 522 of 1 may be a fixed 106 tone RU of either 304.1 or 304.2.

As an example, indication of RU 522 may be represented with a modulation of R-HE-SIGA1 606 or with bit B0 of Table 1 (or anther bit or field). This would provide one bit or 2 possible values for indication of RU 522. In some embodiments, any combination of bits and modulations may be used to provide the two values of the indication of RU 522 of Table 5. In addition, a portion of a range of a field that is not being used for the HE ER SU PPDU 500 may be used, e.g., the unused values for the N_STS field of Table 2.

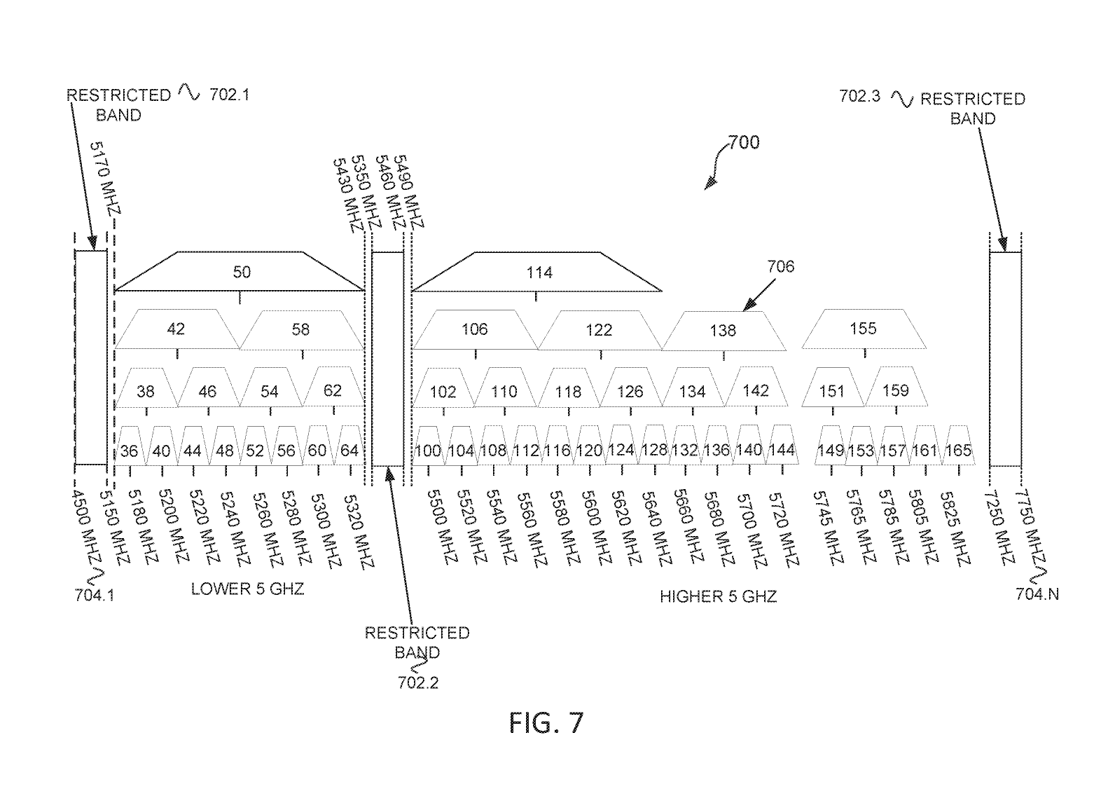

FIG. 7 illustrates bandwidths for channels 704 for the lower 5 GHZ band and the higher 5 GHz band 700 in accordance with some embodiments. Illustrated in FIG. 7 is restricted bands 702, MHz indication 704, and channels 706. Each of the lower channels is 20 MHz, e.g. 36, 40, 100, and 149. Each of the middle channels 706 is 40 MHz, e.g., 38, 46, 102, 110, 151, and 159. Each of the upper middle channels 706 are 80 MHz, e.g., 42, 58, 106, 122, 138, and 155. The top channels 706 are each 160 MHz, e.g., 50 and 114. The restricted bands 702 are bands that are not permitted for use by the HE access point 102 and HE station 104.

Regulations by the government allow different maximum transmission power for different RU (e.g., 204, 304, or 404) in different 20 MHz channels 706. In some embodiments, the HE access point 102 and HE station 104 are configured to use the RU (e.g., 204, 304, 404) within a 20 MHz channel 706 with the largest maximum transmission power as permitted by regulation for a same size RU. For example, channels 36, 40, 100, and 104 within 20 MHz may only use 106 tone RU or 52 RU at the higher frequency of the 20 MHz channel. This may be because the lower frequencies of the 20 MHz channel are nearer the restricted band 702.1 (for channels 36 and 40), and restricted band 702.2 (for channels 100 and 104). The regulations may permit a lower maximum transmit power for the RUs that are nearer the restricted bands.

In some embodiments, not all the RUs (204, 304, and 404) are used for the HE ER SU PPDU 500. For example, RUs that are farther away from restricted bands that permit higher maximum transmit power (or that just permit higher maximum transmit power for another reason) may be used.

TABLE 7
An Embodiment of Indication of RU

| Indication of RU 522 | RU |
|---|---|
| 1 | 52 tone RU 204.3 |
| 2 | 52 tone RU 204.4 |
| 3 | 106 tone RU 304.2 |
| 4 | 242 tone RU 404 |

Table 7 is an embodiment of indication of RU 522. There may be two (4) values for the indication of RU 522 that indicate an RU (e.g., 204, 304, or 404) within a 20 MHz bandwidth. Different indication of RU 522 values may be used to indicate different RUs, e.g., the value of 1 may indicate a 242 tone RU 404 rather than a 52 tone RU 204.3.

As an example, indication of RU 522 may be represented with a modulation of R-HE-SIGA1 606 in conjunction with bit B0 of Table 1 (or, e.g., bits or values of the MCS field). This would provide two bits or 4 possible values for indication of RU 522. In some embodiments, any combination of bits and modulations may be used to provide the three values of the indication of RU 522 of Table 5. In addition, a portion of a range of a field that is not being used for the HE ER SU PPDU 500 may be used, e.g., the unused values for the N_STS field of Table 2.

In some embodiments, 52 tone RU 204.1 and 52 tone RU 204.2 may be used instead of 52 tone RU 204.3 and 52 tone RU 204.4. In some embodiments, 106 tone RU 304.1 may be used rather than 106 tone RU 304.2.

TABLE 8
An Embodiment of Indication of RU

| Indication of RU 522 | RU |
|---|---|
| 1 | 52 tone RU 204 |
| 2 | 106 tone RU 304.1 |
| 3 | 106 tone RU 304.2 |
| 4 | 242 tone RU 404 |

Table 8 is an embodiment of indication of RU 522. There may be two (4) values for the indication of RU 522 that indicate an RU (e.g., 204, 304, or 404) within a 20 MHz bandwidth. Different indication of RU 522 values may be used to indicate different RUs, e.g., the value of 1 may indicate a 242 tone RU 404 rather than a 52 tone RU 204.3. The 52 tone RU 204 may be one of RU 204.1, RU 204.2, RU 204.3, and RU 204.4.

As an example, indication of RU 522 may be represented with a modulation of R-HE-SIGA1 606 in conjunction with bit B0 of Table 1 (or, e.g., bits or values of the BW field). This would provide two bits or 4 possible values for indication of RU 522. In some embodiments, any combination of bits and modulations may be used to provide the three values of the indication of RU 522 of Table 5. In addition, a portion of a range of a field that is not being used for the HE ER SU PPDU 500 may be used, e.g., the unused values for the N_STS field of Table 2.

TABLE 9
An Embodiment of Indication of RU

| Indication of RU 522 | RU |
|---|---|
| 1 | RU 1 dependent on channel |
| 2 | RU 2 dependent on channel |
| 3 | RU 3 dependent on channel |
| 4 | RU 4 dependent on channel |

Table 9 is an embodiment of indication of RU 522. There may be two (4) values for the indication of RU 522 that indicate an RU (e.g., 204, 304, or 404) within a 20 MHz bandwidth. The RU that is indicated may depend on the channel that is indicated in a different portion of the HE ER SU PPDU 500. For example, RU 1 dependent on channel may be 52 tone RU 204.4 for channel 36 and 52 tone RU 204.1 for channel 64. One of the RUs dependent on channel may be the entire 20 MHz bandwidth so that it is not dependent on the channel. For example, RU 4 dependent on channel may be 242 tone RU 404.

As an example, indication of RU 522 may be represented with a modulation of R-HE-SIGA1 606 in conjunction with bit B0 of Table 1 (or, e.g., bits or values of a packet extension field). This would provide two bits or 4 possible values for indication of RU 522. In some embodiments, any combination of bits and modulations may be used to provide the three values of the indication of RU 522 of Table 5. In addition, a portion of a range of a field that is not being used for the HE ER SU PPDU 500 may be used, e.g., the unused values for the N_STS field of Table 2.

TABLE 10
An Embodiment of Indication of RU

| Indication of RU 522 | RU |
|---|---|
| 1 | RU 1 dependent on channel |
| 2 | 242 tone RU 404 |

As an example, indication of RU 522 may be represented with a modulation of R-HE-SIGA1 606 or with bit B0 of Table 1. This would provide one bit or 2 possible values for indication of RU 522. In some embodiments, any combination of bits and modulations may be used to provide the two values of the indication of RU 522 of Table 5. In addition, a portion of a range of a field that is not being used for the HE ER SU PPDU 500 may be used, e.g., the unused values for the N_STS field of Table 2.

Table 10 is an embodiment of indication of RU 522. There may be two (2) values for the indication of RU 522 that indicate an RU (e.g., 204, 304, or 404) within a 20 MHz bandwidth. The RU that is indicated may depend on the channel that is indicated in a different portion of the HE ER SU PPDU 500. For example, RU 1 dependent on channel may be 52 tone RU 204.4 for channel 36 and 52 tone RU 204.1 for channel 64. Or as another example, RU 1 dependent on channel may be 106 tone RU 304.1 for channel 64 and 106 tone RU 304.2 for channel 36.

In some embodiments, there is no indication of RU 522 and there is a fixed location for the RU either for all channels or per channel. For example, for each channel it may be a 106 tone RU 304.1. As another example, 106 tone RU 304.1 may be used for channel 64 and 106 tone RU 304.2 may be used for channel 36. As another example, a 106 tone RU 304 may be used for one channel and a 242 tone RU 404 may be used for another channel.

In some embodiments, the bandwidths for channels 704 for the lower 5 GHZ band and the higher 5 GHz band 700 may different for different countries throughout the world.

In some embodiments, for the lower and higher 5 GHz bands, regulations (e.g., Federal Communications Commission) require out-of-band leakages of −27 dBm per 1 MHz and −42 dBm per 1 MHz for restricted bands. In practice, the transmission power used in the edge channels, e.g. channel 36 need to be reduced by the HE access point 102 and/or HE station 104 to comply with the regulations.

In some embodiments, the 106 tone RU 304 is not considered for the edge 20 MH channel at a restricted band 702 edge, e.g., the 106 tone RU with higher frequency in channel 36 is away from the restricted band 702.1 edge of the lower 5 GHz band, so it may be used for HE ER SU PPDU 500. The RU with lower frequency in channel 36 that is near the restricted band 702.1 may not be used for HE ER SU PPDU 500, in accordance with some embodiments.

In some embodiments, 106 tone RU 304 with higher effective transmission power is used to transmit the HE ER SU PPDU 500. Often, the 106 tone RU 304 with the higher transmission power allowed by regulation is the 106 tone RU 304 away from the restricted band 702 edge. For example, channels (e.g., 20 MHz channels 706) 36, 40, 100, and 104 should use higher frequency 106-tone RUs 304; channels 60, 64, 140, and 144 should use the lower frequency 106-tone RUs 304. For the channels 706 (e.g., 20 MHz) away from the band edges, the HE access point 102 and/or HE station 104 may use 106 tone RU 304 with the higher transmission power allowed by regulation. In some embodiments, either the higher or lower frequency 106-tone RU 304 is used for consistency.

For mitigating interference among cells, i.e. BSS 100 and overlapping BSSs (OBSS), the HE access points 102 may select different 106-tone RUs 304 for their HE ER SU PPDU 500 using the same channels 706 to reduce collisions and/or interference. The selection of the 106 tone RU 304 may be broadcasted to the HE stations 104 associated with the HE access point 102.

In some embodiments, the HE access point 102 and HE station 104 are configured to store a table in memory that indicates for each of a plurality of 20 MHz channels an RU indicated by each of a plurality of values for the indication of the RU. For example, the HE access point 102 and HE station 104 may store a table that includes each of channels 36, 40, 44, 48, 52, 56, 60, 64, 100, 104, 108, 112, 116, 120, 124, 128, 132, 136, 140, 144, 149, 153, 157, 161, and 165, and for each channel an indication of an RU configuration, e.g., for channel 36 the RU configuration may be Table 7 and for channel 64 the RU configuration may be Table 8. In some embodiments, the HE access point 102 and HE station 104 access a table from memory that indicates for each of the plurality of 20 MHz channels an RU configuration that indicates a mapping between values for the indication of the RU and RUs of a corresponding 20 MHz channel, e.g. table 7 and table 8.

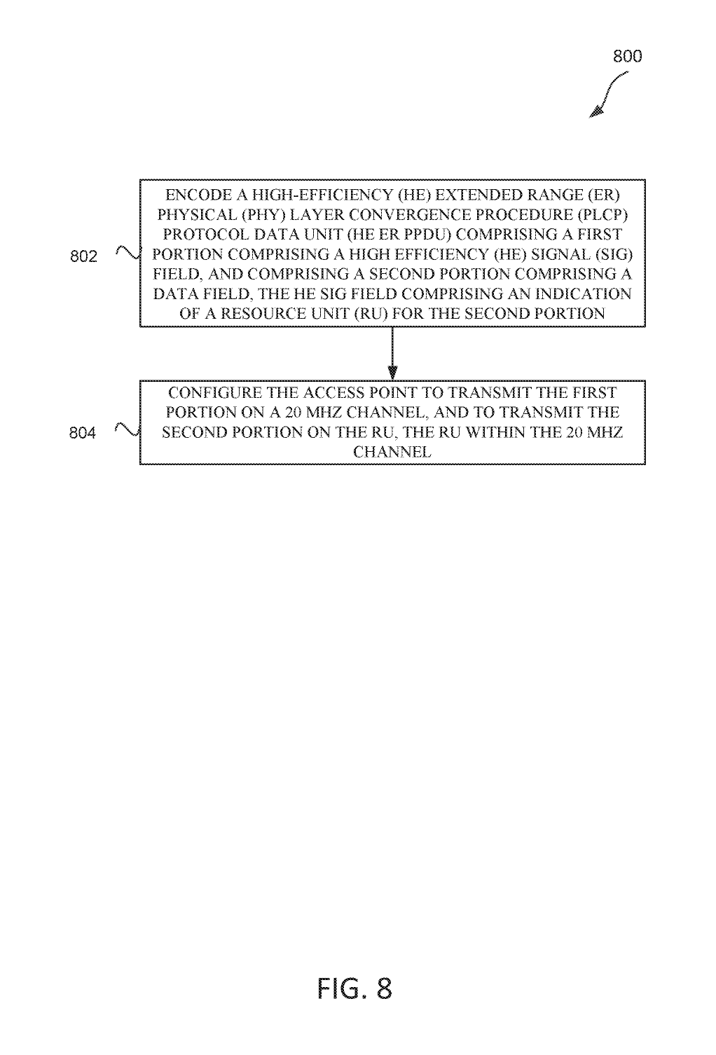

FIG. 8 a method 800 for RU indication for HE ER SU PPDU in accordance with some embodiments. The method 800 begins at operation 802 with encoding a HE ER PPDU comprising a first portion comprising a high efficiency (HE) signal (SIG) field, and comprising a second portion comprising a data field, the HE SIG field comprising an indication of a resource unit (RU) for the second portion. For example, HE access point 102 may encode a HE ER PPDU 500 comprising a first part that include the indication of RU 522 and a second part that includes the data 518. Operation 802 may be performed by an apparatus of a HE access point 102.

The method 800 continues at operation 804 with configuring the access point to transmit the first portion on a 20 MHz channel, and to transmit the second portion on the RU, the RU within the 20 MHz channel. For example, an apparatus of the HE access point 102 may be configured to configure the HE access point 102 to transmit the HE-SIG-A 512 on a 20 MHz channel (e.g., channel 36 of FIG. 7) and to transmit data 518 on an RU within the 20 MHz channel (e.g., RU 204, 304, or 404.) In some embodiments, the RU to transmit data 518 is less than 20 MHz, e.g., RU 204, 304, or 404.

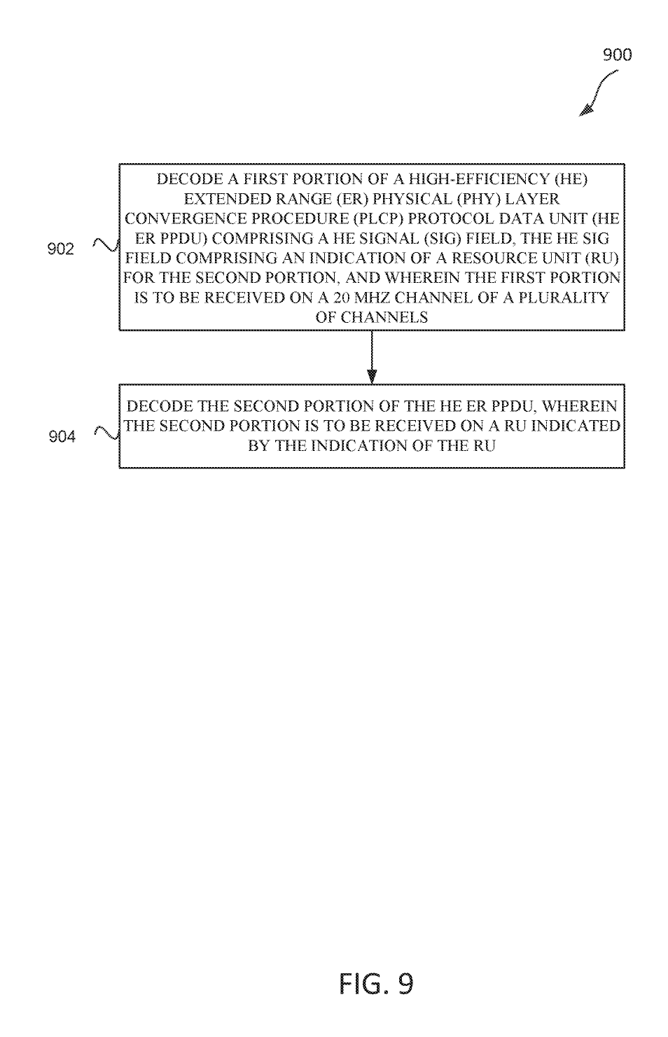

FIG. 9 a method 900 for RU indication for HE ER SU PPDU in accordance with some embodiments. The method 900 begins at operation 902 with decoding a first portion of a HE ER PPDU comprising a HE SIG field, the HE SIG field comprising an indication of a RU for the second portion, and wherein the first portion is to be received on a 20 MHz channel of a plurality of channels.

For example, HE station 104 may decode a first portion of a HE ER PPDU 500 including the indication of RU 522. The HE ER PPDU 500 may be received on a 20 MHz channel, e.g., channel 36 of FIG. 7. Operation 902 may be performed by an apparatus of the HE station 104.

The method 900 continues at operation 904 with decoding the second portion of the HE ER PPDU, wherein the second portion is to be received on a RU indicated by the indication of the RU. For example, the HE station 104 may decode the data 518 portion of HE ER PPDU 500, where it is to be received on an RU (e.g., RU 204, 304, 404) of the 20 MHz channel (e.g., channel 36 of FIG. 7).

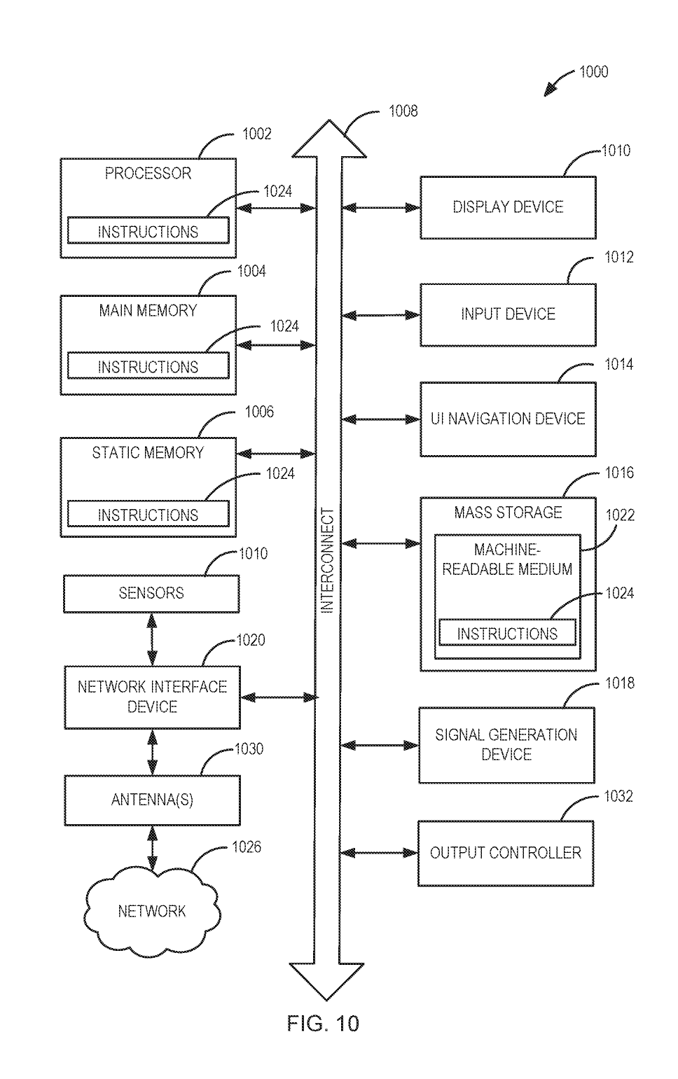

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a HE access point 102, HE station 104, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008.

Specific examples of main memory 1004 include Random Access Memory (RAM), and semiconductor memory devices, which may include, in some embodiments, storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1000 may further include a display device 1010, an input device 1012 (e.g., a keyboard), and a user interface (UI) navigation device 1014 (e.g., a mouse). In an example, the display device 1010, input device 1012 and UI navigation device 1014 may be a touch screen display. The machine 1000 may additionally include a mass storage (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 1002 and/or instructions 1024 may comprise processing circuitry and/or transceiver circuitry.

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 1022 is illustrated as a single medium, the term “machine readable medium” may include a single medium or multiple media (e.g., a centralized or distributed database, and/or associated caches and servers) configured to store the one or more instructions 1024.

An apparatus of the machine 1000 may be one or more of a hardware processor 1002 (e.g., a central processing unit (CPU), a graphics processing unit (GPU), a hardware processor core, or any combination thereof), a main memory 1004 and a static memory 1006, sensors 1021, network interface device 1020, antennas 1060, a display device 1010, an input device 1012, a UI navigation device 1014, a mass storage 1016, instructions 1024, a signal generation device 1018, and an output controller 1028. The apparatus may be configured to perform one or more of the methods and/or operations disclosed herein. The apparatus may be intended as a component of the machine 1000 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1020 may include one or more physical jacks (e.g., Ethernet, coaxial, or phone jacks) or one or more antennas to connect to the communications network 1026. In an example, the network interface device 1020 may include one or more antennas 1060 to wirelessly communicate using at least one of single-input multiple-output (SIMO), multiple-input multiple-output (MIMO), or multiple-input single-output (MISO) techniques. In some examples, the network interface device 1020 may wirelessly communicate using Multiple User MIMO techniques. The term “transmission medium” shall be taken to include any intangible medium that is capable of storing, encoding or carrying instructions for execution by the machine 1000, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The following examples pertain to further embodiments. Example 1 is an apparatus of an access point including: a memory; and processing circuitry coupled to the memory, where the processing circuitry is configured to: encode a high-efficiency (HE) extended range (ER) physical (PHY) layer convergence procedure (PLCP) protocol data unit (HE ER PPDU) including a first portion including a HE signal (SIG) field, and including a second portion including a data field, the HE SIG field including an indication of a resource unit (RU) for the second portion; and configure the access point to transmit the first portion on a 20 MHz channel, and to transmit the second portion on the RU, the RU less than 20 MHz and within the 20 MHz channel.

In Example 2, the subject matter of Example 1 optionally includes tones.

In Example 3, the subject matter of any one or more of Examples 1-2 optionally include field.

In Example 4, the subject matter of Example 3 optionally includes

In Example 5, the subject matter of Example 4 optionally includes where the indication of the RU is represented by one or more from the following group: bit 0 of the HE SIG A1 field, bit 15 of the HE SIG A1 field, bit 1 of the HE SIG A1 field, bit 20 of the HE SIG A1 field, bit 21 of the HE SIG A1 field, bit 22 of the HE SIG A1 field, bit 23 of the HE SIG A1 field, bit 24 of the HE SIG A1 field, bit 25 of the HE SIG A1 field, bit 4 of the HE SIG A2 field, bit 5 of the HE SIG A2 field, bit 6 of the HE SIG A2 field, bit 10 of the HE SIG A2 field, bit 11 of the HE SIG A2 field, bit 12 of the HE SIG A2 field, bit 0 of the HE SIG A2 field, bit 1 of the HE SIG A2 field, a modulation of the R HE SIG A1, a modulation of the R HE SIG A2, and a selection of the 20 MHz channel.

In Example 6, the subject matter of any one or more of Examples 4-5 optionally include where the indication of the RU is represented by one or more from the following group: reserved bits of the HE SIG A1 field, a format field of the HE SIG A1 field, bits of a bandwidth field of the HE SIG A1, bits or values of a modulation and coding scheme field of the HE SIG A1, bits of a spatial stream indication field of the HE SIG A2, bits or values of a packet extension field of the HE SIG A2, bits or values of a cyclic prefix and long training type filed, modulation of the R HE SIG A1, modulation of the R HE SIG A2 field, reserved bits of the HE SIG A2 field, and a selection of the 20 MHz channel.

In Example 7, the subject matter of any one or more of Examples 1-6 optionally include MHz channels the HE ER PPDU is to be transmitted on.

In Example 8, the subject matter of Example 7 optionally includes where the processing circuitry is configured to: access a table from memory that indicates for each of the plurality of 20 MHz channels an RU configuration that indicates a mapping between values for the indication of the RU and RUs of a corresponding 20 MHz channel.

In Example 9, the subject matter of any one or more of Examples 1-8 optionally include where the processing circuitry is further configured to: decode an acknowledgment for the HE ER PPDU from a station, where the acknowledgment is to be received on the 20 MHz channel or the RU indicated by the indication of the RU.

In Example 10, the subject matter of any one or more of Examples 1-9 optionally include where the first portion further comprises: a legacy signal field indicating a duration of the HE ER PPDU.

In Example 11, the subject matter of any one or more of Examples 1-10 optionally include where the second portion further comprises: a HE short training field and one or more HE long training field.

In Example 12, the subject matter of any one or more of Examples 1-11 optionally include ax station.

In Example 13, the subject matter of any one or more of Examples 1-12 optionally include transceiver circuitry coupled to the memory; and, one or more antennas coupled to the transceiver circuitry.

Example 14 is a non-transitory computer-readable storage medium that stores instructions for execution by one or more processors, the instructions to configure the one or more processors to cause an apparatus of an access point to: encode a high-efficiency (HE) extended range (ER) physical (PHY) layer convergence procedure (PLCP) protocol data unit (HE ER PPDU) including a first portion including a high efficiency (HE) signal (SIG) field, and including a second portion including a data field, the HE SIG field including an indication of a resource unit (RU) for the second portion; and configure the access point to transmit the first portion on a 20 MHz channel, and to transmit the second portion on the RU, the RU within the 20 MHz channel.

In Example 15, the subject matter of Example 14 optionally includes tones.

In Example 16, the subject matter of any one or more of Examples 14-15 optionally include

In Example 17, the subject matter of any one or more of Examples 14-16 optionally include where the indication of the RU is represented by one or more from the following group: bit 0 of the HE SIG A1 field, bit 15 of the HE SIG A1 field, bit 1 of the HE SIG A1 field, bit 20 of the HE SIG A1 field, bit 21 of the HE SIG A1 field, bit 22 of the HE SIG A1 field, bit 23 of the HE SIG A1 field, bit 24 of the HE SIG A1 field, bit 25 of the HE SIG A1 field, bit 4 of the HE SIG A2 field, bit 5 of the HE SIG A2 field, bit 6 of the HE SIG A2 field, bit 10 of the HE SIG A2 field, bit 11 of the HE SIG A2 field, bit 12 of the HE SIG A2 field, bit 0 of the HE SIG A2 field, bit 1 of the HE SIG A2 field, a modulation of the R HE SIG A1, a modulation of the R HE SIG A2, and a selection of the 20 MHz channel.

Example 18 is a method performed by an apparatus of an access point, the method including: encoding a high-efficiency (HE) extended range (ER) physical (PHY) layer convergence procedure (PLCP) protocol data unit (HE ER PPDU) including a first portion including a high efficiency (HE) signal (SIG) field, and including a second portion including a data field; and determining a resource unit (RU) based on a 20 MHz channel of a plurality of 20 MHz channels to transmit the first portion; and configuring the access point to transmit the first portion on a 20 MHz channel, and to transmit the second portion on the RU, the RU within the 20 MHz channel.

In Example 19, the subject matter of Example 19 optionally includes the method further including: determining the RU by accessing a relationship from memory that indicates for each of the plurality of 20 MHz channels the RU to transmit the second portion of the HE ER PPDU.

Example 20 is an apparatus of a station including: a memory; and processing circuitry couple to the memory, where the processing circuitry is configured to: decode a first portion of a high-efficiency (HE) extended range (ER) physical (PHY) layer convergence procedure (PLCP) protocol data unit (HE ER PPDU) including a HE signal (SIG) field, the HE SIG field including an indication of a resource unit (RU) for the second portion, and where the first portion is to be received on a 20 MHz channel of a plurality of channels; and decode the second portion of the HE ER PPDU, where the second portion is to be received on a RU indicated by the indication of the RU.

In Example 21, the subject matter of Example 20 optionally includes tones.

In Example 22, the subject matter of any one or more of Examples 20-21 optionally include

In Example 23, the subject matter of Example 22 optionally includes where the indication of the RU is represented by one or more from the following group: bit 0 of the HE SIG A1 field, bit 15 of the HE SIG A1 field, bit 1 of the HE SIG A1 field, bit 20 of the HE SIG A1 field, bit 21 of the HE SIG A1 field, bit 22 of the HE SIG A1 field, bit 23 of the HE SIG A1 field, bit 24 of the HE SIG A1 field, bit 25 of the HE SIG A1 field, bit 4 of the HE SIG A2 field, bit 5 of the HE SIG A2 field, bit 6 of the HE SIG A2 field, bit 10 of the HE SIG A2 field, bit 11 of the HE SIG A2 field, bit 12 of the HE SIG A2 field, bit 0 of the HE SIG A2 field, bit 1 of the HE SIG A2 field, a modulation of the R HE SIG A1, a modulation of the R HE SIG A2, a selection of the 20 MHz channel, reserved bits of the HE SIG A1 field, a format field of the HE SIG A1 field, bits of a bandwidth field of the HE SIG A1 bits or values of a modulation and coding scheme field of the HE SIG A1 bits of a spatial stream indication field of the HE SIG A2 bits or values of a packet extension field of the HE SIG A2 bits or values of a cyclic prefix and long training type filed modulation of the R HE SIG A1, modulation of the R HE SIG A2 field reserved bits of the HE SIG A2 field, and a selection of the 20 MHz channel.

In Example 24, the subject matter of any one or more of Examples 20-23 optionally include ax station.

In Example 25, the subject matter of any one or more of Examples 20-24 optionally include transceiver circuitry coupled to the memory; and, one or more antennas coupled to the transceiver circuitry.

Example 26 is an apparatus of an access point including: means for encoding a high-efficiency (HE) extended range (ER) physical (PHY) layer convergence procedure (PLCP) protocol data unit (HE ER PPDU) including a first portion including a HE signal (SIG) field, and including a second portion including a data field, the HE SIG field including an indication of a resource unit (RU) for the second portion; and means for configuring the access point to transmit the first portion on a 20 MHz channel, and to transmit the second portion on the RU, the RU less than 20 MHz and within the 20 MHz channel.

In Example 27, the subject matter of Example 26 optionally includes tones.

In Example 28, the subject matter of any one or more of Examples 26-27 optionally include field.

In Example 29, the subject matter of Example 28 optionally includes

In Example 30, the subject matter of Example 29 optionally includes where the indication of the RU is represented by one or more from the following group: bit field, bit 21 of the HE SIG A1 field, bit 22 of the HE SIG A1 field, bit 23 of the HE SIG A1 field, bit 24 of the HE SIG A1 field, bit 25 of the HE SIG A1 field, bit 4 of the HE SIG A2 field, bit 5 of the HE SIG A2 field, bit 6 of the HE SIG A2 field, bit 10 of the HE SIG A2 field, bit 11 of the HE SIG A2 field, bit 12 of the HE SIG A2 field, bit 0 of the HE SIG A2 field, bit 1 of the HE SIG A2 field, a modulation of the R HE SIG A1, a modulation of the R HE SIG A2, and a selection of the 20 MHz channel.

In Example 31, the subject matter of any one or more of Examples 29-30 optionally include where the indication of the RU is represented by one or more from the following group: reserved bits of the HE SIG A1 field, a format field of the HE SIG A1 field, bits of a bandwidth field of the HE SIG A1, bits or values of a modulation and coding scheme field of the HE SIG A1, bits of a spatial stream indication field of the HE SIG A2, bits or values of a packet extension field of the HE SIG A2, bits or values of a cyclic prefix and long training type filed, modulation of the R HE SIG A1, modulation of the R HE SIG A2 field, reserved bits of the HE SIG A2 field, and a selection of the 20 MHz channel.

In Example 32, the subject matter of any one or more of Examples 29-31 optionally include MHz channels the HE ER PPDU is to be transmitted on.

In Example 33, the subject matter of Example 32 optionally includes where the apparatus further comprises: means for accessing a table from memory that indicates for each of the plurality of 20 MHz channels an RU configuration that indicates a mapping between values for the indication of the RU and RUs of a corresponding 20 MHz channel.

In Example 34, the subject matter of any one or more of Examples 26-33 optionally include where the apparatus further comprises: means for decoding an acknowledgment for the HE ER PPDU from a station, where the acknowledgment is to be received on the 20 MHz channel or the RU indicated by the indication of the RU.

In Example 35, the subject matter of any one or more of Examples 26-34 optionally include where the first portion further comprises: a legacy signal field indicating a duration of the HE ER PPDU.

In Example 36, the subject matter of any one or more of Examples 26-35 optionally include where the second portion further comprises: a HE short training field and one or more HE long training field.

In Example 37, the subject matter of any one or more of Examples 26-36 optionally include ax station.

Example 38 is a non-transitory computer-readable storage medium that stores instructions for execution by one or more processors, the instructions to configure the one or more processors to cause an apparatus of a station to: decode a first portion of a high-efficiency (HE) extended range (ER) physical (PHY) layer convergence procedure (PLCP) protocol data unit (HE ER PPDU) including a HE signal (SIG) field, the HE SIG field including an indication of a resource unit (RU) for the second portion, and where the first portion is to be received on a 20 MHz channel of a plurality of channels; and decode the second portion of the HE ER PPDU, where the second portion is to be received on a RU indicated by the indication of the RU.

In Example 39, the subject matter of Example 38 optionally includes tones.

In Example 40, the subject matter of any one or more of Examples 38-39 optionally include

In Example 41, the subject matter of any one or more of Examples 38-40 optionally include where the indication of the RU is represented by one or more from the following group: bit 0 of the HE SIG A1 field, bit 15 of the HE SIG A1 field, bit 1 of the HE SIG A1 field, bit 20 of the HE SIG A1 field, bit 21 of the HE SIG A1 field, bit 22 of the HE SIG A1 field, bit 23 of the HE SIG A1 field, bit 24 of the HE SIG A1 field, bit 25 of the HE SIG A1 field, bit 4 of the HE SIG A2 field, bit 5 of the HE SIG A2 field, bit 6 of the HE SIG A2 field, bit 10 of the HE SIG A2 field, bit 11 of the HE SIG A2 field, bit 12 of the HE SIG A2 field, bit 0 of the HE SIG A2 field, bit 1 of the HE SIG A2 field, a modulation of the R HE SIG A1, a modulation of the R HE SIG A2, a selection of the 20 MHz channel, reserved bits of the HE SIG A1 field, a format field of the HE SIG A1 field, bits of a bandwidth field of the HE SIG A1 bits or values of a modulation and coding scheme field of the HE SIG A1 bits of a spatial stream indication field of the HE SIG A2 bits or values of a packet extension field of the HE SIG A2 bits or values of a cyclic prefix and long training type filed modulation of the R HE SIG A1, modulation of the R HE SIG A2 field reserved bits of the HE SIG A2 field, and a selection of the 20 MHz channel.

In Example 42, the subject matter of any one or more of Examples 38-41 optionally include ax station.

Example 43 is a method performed by an apparatus of a station, the method including: decoding a first portion of a high-efficiency (HE) extended range (ER) physical (PHY) layer convergence procedure (PLCP) protocol data unit (HE ER PPDU) including a HE signal (SIG) field, the HE SIG field including an indication of a resource unit (RU) for the second portion, and where the first portion is to be received on a 20 MHz channel of a plurality of channels; and decoding the second portion of the HE ER PPDU, where the second portion is to be received on a RU indicated by the indication of the RU.

In Example 44, the subject matter of Example 43 optionally includes tones.

In Example 45, the subject matter of any one or more of Examples 43-44 optionally include

In Example 46, the subject matter of any one or more of Examples 43-45 optionally include where the indication of the RU is represented by one or more from the following group: bit 0 of the HE SIG A1 field, bit 15 of the HE SIG A1 field, bit 1 of the HE SIG A1 field, bit 20 of the HE SIG A1 field, bit 21 of the HE SIG A1 field, bit 22 of the HE SIG A1 field, bit 23 of the HE SIG A1 field, bit 24 of the HE SIG A1 field, bit 25 of the HE SIG A1 field, bit 4 of the HE SIG A2 field, bit 5 of the HE SIG A2 field, bit 6 of the HE SIG A2 field, bit 10 of the HE SIG A2 field, bit 11 of the HE SIG A2 field, bit 12 of the HE SIG A2 field, bit 0 of the HE SIG A2 field, bit 1 of the HE SIG A2 field, a modulation of the R HE SIG A1, a modulation of the R HE SIG A2, a selection of the 20 MHz channel, reserved bits of the HE SIG A1 field, a format field of the HE SIG A1 field, bits of a bandwidth field of the HE SIG A1 bits or values of a modulation and coding scheme field of the HE SIG A1 bits of a spatial stream indication field of the HE SIG A2 bits or values of a packet extension field of the HE SIG A2 bits or values of a cyclic prefix and long training type filed modulation of the R HE SIG A1, modulation of the R HE SIG A2 field reserved bits of the HE SIG A2 field, and a selection of the 20 MHz channel.

In Example 47, the subject matter of any one or more of Examples 43-46 optionally include ax station.

Example 48 is an apparatus of a station, the apparatus including: means for decoding a first portion of a high-efficiency (HE) extended range (ER) physical (PHY) layer convergence procedure (PLCP) protocol data unit (HE ER PPDU) including a HE signal (SIG) field, the HE SIG field including an indication of a resource unit (RU) for the second portion, and where the first portion is to be received on a 20 MHz channel of a plurality of channels; and means for decoding the second portion of the HE ER PPDU, where the second portion is to be received on a RU indicated by the indication of the RU.

In Example 49, the subject matter of Example 48 optionally includes tones.

In Example 50, the subject matter of any one or more of Examples 48-49 optionally include

In Example 51, the subject matter of any one or more of Examples 48-50 optionally include where the indication of the RU is represented by one or more from the following group: bit 0 of the HE SIG A1 field, bit 15 of the HE SIG A1 field, bit 1 of the HE SIG A1 field, bit 20 of the HE SIG A1 field, bit 21 of the HE SIG A1 field, bit 22 of the HE SIG A1 field, bit 23 of the HE SIG A1 field, bit 24 of the HE SIG A1 field, bit 25 of the HE SIG A1 field, bit 4 of the HE SIG A2 field, bit 5 of the HE SIG A2 field, bit 6 of the HE SIG A2 field, bit 10 of the HE SIG A2 field, bit 11 of the HE SIG A2 field, bit 12 of the HE SIG A2 field, bit 0 of the HE SIG A2 field, bit 1 of the HE SIG A2 field, a modulation of the R HE SIG A1, a modulation of the R HE SIG A2, a selection of the 20 MHz channel, reserved bits of the HE SIG A1 field, a format field of the HE SIG A1 field, bits of a bandwidth field of the HE SIG A1 bits or values of a modulation and coding scheme field of the HE SIG A1 bits of a spatial stream indication field of the HE SIG A2 bits or values of a packet extension field of the HE SIG A2 bits or values of a cyclic prefix and long training type filed modulation of the R HE SIG A1, modulation of the R HE SIG A2 field reserved bits of the HE SIG A2 field, and a selection of the 20 MHz channel.

In Example 52, the subject matter of any one or more of Examples 48-51 optionally include ax station.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point comprising: a memory; and processing circuitry coupled to the memory, wherein the processing circuitry is configured to:
encode a high-efficiency (HE) extended range (ER) physical (PHY) layer convergence procedure (PLCP) protocol data unit (HE ER PPDU) comprising a first portion comprising a HE signal (SIG) field, and comprising a second portion comprising a data field, the HE SIG field comprising an indication of a resource unit (RU) for the second portion; and
configure the access point to transmit the first portion on a 20 MHz channel, and to transmit the second portion on the RU, the RU less than 20 MHz and within the 20 MHz channel.

2. The apparatus of claim 1, wherein the RU indicated by the indication is one from the following group: 52 tones, 106 tones, or 242 tones.

3. The apparatus of claim 1, wherein the HE SIG field comprises: a HE SIG A1 field and a HE SIG A2 field.

4. The apparatus of claim 3, wherein the HE SIG field further comprises a repeated (R) HE SIG A1 field and a R HE SIG A2.

5. The apparatus of claim 4, wherein the indication of the RU is represented by one or more from the following group:
bit 0 of the HE SIG A1 field, bit 15 of the HE SIG A1 field,
bit 1 of the HE SIG A1 field,
bit 20 of the HE SIG A1 field, bit 21 of the HE SIG A1 field,
bit 22 of the HE SIG A1 field, bit 23 of the HE SIG A1 field, bit 24 of the HE SIG A1 field, bit 25 of the HE SIG A1 field,
bit 4 of the HE SIG A2 field, bit 5 of the HE SIG A2 field, bit 6 of the HE SIG A2 field,
bit 10 of the HE SIG A2 field, bit 11 of the HE SIG A2 field, bit 12 of the HE SIG A2 field,
bit 0 of the HE SIG A2 field, bit 1 of the HE SIG A2 field,
a modulation of the R HE SIG A1, a modulation of the R HE SIG A2, and
a selection of the 20 MHz channel.

6. The apparatus of claim 4, wherein the indication of the RU is represented by one or more from the following group:
reserved bits of the HE SIG A1 field,
a format field of the HE SIG A1 field,
bits of a bandwidth field of the HE SIG A1,
bits or values of a modulation and coding scheme field of the HE SIG A1,
bits of a spatial stream indication field of the HE SIG A2,
bits or values of a packet extension field of the HE SIG A2,
bits or values of a cyclic prefix and long training type filed,
modulation of the R HE SIG A1, modulation of the R HE SIG A2 field,
reserved bits of the HE SIG A2 field, and
a selection of the 20 MHz channel.

7. The apparatus of claim 1, wherein the HE ER PPDU indicates the 20 MHz channel of a plurality of 20 MHz channels, and wherein the RU indicated by the indication of the RU depends on which 20 MHz channel of a plurality of 20 MHz channels the HE ER PPDU is to be transmitted on.

8. The apparatus of claim 7, wherein the processing circuitry is configured to:
access a table from memory that indicates for each of the plurality of 20 MHz channels an RU configuration that indicates a mapping between values for the indication of the RU and RUs of a corresponding 20 MHz channel.

9. The apparatus of claim 1, wherein the processing circuitry is further configured to:
decode an acknowledgment for the HE ER PPDU from a station, wherein the acknowledgment is to be received on the 20 MHz channel or the RU indicated by the indication of the RU.

10. The apparatus of claim 1, wherein the first portion further comprises: a legacy signal field indicating a duration of the HE ER PPDU.

11. The apparatus of claim 1, wherein the second portion further comprises: a HE short training field and one or more HE long training field.

12. The apparatus of claim 1, wherein the access point is one or more from the following group: an Institute of Electrical and Electronic Engineers (IEEE) 802.11ax access point, an IEEE 802.11 station, an IEEE access point, a station acting as a group owner (GO), and an IEEE 802.11ax station.

13. The apparatus of claim 1, further comprising transceiver circuitry coupled to the memory; and, one or more antennas coupled to the transceiver circuitry.

14. A non-transitory computer-readable storage medium that stores instructions for execution by one or more processors, the instructions to configure the one or more processors to cause an apparatus of an access point to:
encode a high-efficiency (HE) extended range (ER) physical (PHY) layer convergence procedure (PLCP) protocol data unit (HE ER PPDU) comprising a first portion comprising a high efficiency (HE) signal (SIG) field, and comprising a second portion comprising a data field, the HE SIG field comprising an indication of a resource unit (RU) for the second portion; and
configure the access point to transmit the first portion on a 20 MHz channel, and to transmit the second portion on the RU, the RU within the 20 MHz channel.

15. The non-transitory computer-readable storage medium of claim 14, wherein the RU indicated by the indication of the RU is one from the following group: 52 tones, 106 tones, or 242 tones.

16. The non-transitory computer-readable storage medium of claim 14, wherein the HE SIG field comprises: a HE SIG A1 field, a HE SIG A2 field, a repeated (R) HE SIG A1 field, and a R HE SIG A2.

17. The non-transitory computer-readable storage medium of claim 14, wherein the indication of the RU is represented by one or more from the following group:
bit 0 of the HE SIG A1 field, bit 15 of the HE SIG A1 field,
bit 1 of the HE SIG A1 field,
bit 20 of the HE SIG A1 field, bit 21 of the HE SIG A1 field,
bit 22 of the HE SIG A1 field, bit 23 of the HE SIG A1 field, bit 24 of the HE SIG A1 field, bit 25 of the HE SIG A1 field,
bit 4 of the HE SIG A2 field, bit 5 of the HE SIG A2 field, bit 6 of the HE SIG A2 field,
bit 10 of the HE SIG A2 field, bit 11 of the HE SIG A2 field, bit 12 of the HE SIG A2 field,
bit 0 of the HE SIG A2 field, bit 1 of the HE SIG A2 field,
a modulation of the R HE SIG A1, a modulation of the R HE SIG A2, and
a selection of the 20 MHz channel.

18. A method performed by an apparatus of an access point, the method comprising:
encoding a high-efficiency (HE) extended range (ER) physical (PHY) layer convergence procedure (PLCP) protocol data unit (HE ER PPDU) comprising a first portion comprising a high efficiency (HE) signal (SIG) field, and comprising a second portion comprising a data field; and
determining a resource unit (RU) based on a 20 MHz channel of a plurality of 20 MHz channels to transmit the first portion; and
configuring the access point to transmit the first portion on a 20 MHz channel, and to transmit the second portion on the RU, the RU within the 20 MHz channel.

19. The method of claim 19, the method further comprising:
determining the RU by accessing a relationship from memory that indicates for each of the plurality of 20 MHz channels the RU to transmit the second portion of the HE ER PPDU.

20. An apparatus of a station comprising: a memory; and processing circuitry couple to the memory, wherein the processing circuitry is configured to:
decode a first portion of a high-efficiency (HE) extended range (ER) physical (PHY) layer convergence procedure (PLCP) protocol data unit (HE ER PPDU) comprising a HE signal (SIG) field, the HE SIG field comprising an indication of a resource unit (RU) for the second portion, and wherein the first portion is to be received on a 20 MHz channel of a plurality of channels; and
decode the second portion of the HE ER PPDU, wherein the second portion is to be received on a RU indicated by the indication of the RU.

21. The apparatus of claim 20, wherein the RU indicated by the indication of the RU is one from the following group: 52 tones, 106 tones, or 242 tones.

22. The apparatus of claim 20, wherein the HE SIG field comprises: a HE SIG A1 field and a HE SIG A2 field, a repeated (R) HE SIG A1 field and a R HE SIG A2.

23. The apparatus of claim 22, wherein the indication of the RU is represented by one or more from the following group:
bit 0 of the HE SIG A1 field, bit 15 of the HE SIG A1 field,
bit 1 of the HE SIG A1 field,
bit 20 of the HE SIG A1 field, bit 21 of the HE SIG A1 field,
bit 22 of the HE SIG A1 field, bit 23 of the HE SIG A1 field, bit 24 of the HE SIG A1 field, bit 25 of the HE SIG A1 field,
bit 4 of the HE SIG A2 field, bit 5 of the HE SIG A2 field, bit 6 of the HE SIG A2 field,
bit 10 of the HE SIG A2 field, bit 11 of the HE SIG A2 field, bit 12 of the HE SIG A2 field,
bit 0 of the HE SIG A2 field, bit 1 of the HE SIG A2 field,
a modulation of the R HE SIG A 1, a modulation of the R HE SIG A2,
a selection of the 20 MHz channel,
reserved bits of the HE SIG A1 field,
a format field of the HE SIG A1 field,
bits of a bandwidth field of the HE SIG A1
bits or values of a modulation and coding scheme field of the HE SIG A1
bits of a spatial stream indication field of the HE SIG A2
bits or values of a packet extension field of the HE SIG A2
bits or values of a cyclic prefix and long training type filed
modulation of the R HE SIG A1, modulation of the R HE SIG A2 field
reserved bits of the HE SIG A2 field, and
a selection of the 20 MHz channel.

24. The apparatus of claim 20, wherein the station and the access point each are one or more from the following group: an Institute of Electrical and Electronic Engineers (IEEE) 802.11ax access point, an IEEE 802.11 station, an IEEE access point, a station acting as a group owner (GO), and an IEEE 802.11ax station.

25. The apparatus of claim 20, further comprising transceiver circuitry coupled to the memory; and, one or more antennas coupled to the transceiver circuitry.
